(19) United States
(12) Patent Application Publication
(10) Pub. No.: US 2005/0042359 A1
(43) Pub. Date: Feb. 24, 2005

(54) Method of preparing a potato based food product

(76) Inventor: John G. Howard, Kings Lynn (GB)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/490,838

(22) PCT Filed: Sep. 25, 2002
(86) PCT No.: PCT/GB02/04332

(30) Foreign Application Priority Data
Sep. 25, 2001 (GB) 01230150

(51) Int. Cl. A23L 1/216

(52) U.S. Cl. 426/637

(57) ABSTRACT

The present invention discloses a method of preparing a potato based food product, the method comprising the steps of: processing potatoes into potato articles having a desired size and shape, blanching said potato articles; coating said blanched potato articles with an emulsion, said emulsion containing starch; drying said emulsion coated potato articles; introducing said dried and coated potato articles into an elevated temperature environment for a predetermined period of time; removing said potato articles from said environment and allowing said articles to cool; and packing said articles.

The present invention relates to the preparation of a food product and in particular to the preparation of a potato based food product.

One method of preparing par-cooked potato product, such as chips, is to wash, cut and blanch the raw potato, dry by about 10% and par-fry for about 3 minutes at 140° C. Such chips are then cooled and bagged ready for chilling or freezing. Such par-cooked chips are typically fried to complete the cooking process. This method permits rapid preparation of chips for the plate and such chips have acceptable taste and mouth feel. Par-cooking by frying results in a relatively high final fat content, which it would be desirable to reduce.

According to the present invention there is provided a method of preparing a potato based food product, the method comprising the steps of:
processing potatoes into potato articles having a desired size and shape, blanching said potato articles;
coating said blanched potato articles with an emulsion, said emulsion containing starch;
drying said emulsion coated potato articles;
introducing said dried and coated potato articles into an elevated temperature environment for a predetermined period of time;
removing said potato articles from said environment and allowing said articles to cool; and
packing said articles.

It will be appreciated that the present invention avoids the frying of the potato articles in oil. The present invention thus enables the preparation of par-cooked potato articles which have an acceptable eating quality yet have a much lower fat content than similar potato articles prepared by conventional par-cooking methods. The minimal fat content of the articles is governed by the fat content of the emulsion, the amount of emulsion added to the articles and dehydration of the articles during the time spent in the elevated temperature environment.

The step of processing of said potatoes may comprise washing and peeling the potatoes, followed by cutting into a desired shape such as, for example, elongate sticks known as chips or fries. Typically chips or fries are made available in two sizes wherein the sticks have an approximate cross-section of 8 mm square or 15 mm square, respectively. In an alternative embodiment the potatoes may be processed so as to provide articles having a less regular shape. For example the potatoes may remain substantially whole or, depending upon their size, may be halved or quartered after having been washed and peeled. Potatoes which have been processed thus may form the basis for roast potato articles. In yet a further alternative the potatoes may be washed and then cut into wedge shapes with their skin left on.

Blanching of the potato articles may comprise blanching at a substantially uniform temperature for a predetermined time. In such an embodiment the blanching temperature may be in the range of 70° C. to 95° C., while the predetermined time may be in the range of 5 minutes to 20 minutes. More preferably the blanching temperature may be in the range of 75° C. to 90° C., while the predetermined time may be in the range of 9 minutes to 16 minutes.

Alternatively the blanching step may comprise the utilisation of a succession of differing blanching temperatures for different time periods. In such an alternative embodiment the blanching step may comprise blanching at a first temperature for a first time period followed by blanching at a second temperature for a second time period wherein the second temperature is less than the first temperature and the second time period is greater than the first time period. A third blanching procedure may follow the second blanching procedure. Such a third blanching procedure comprises blanching the potato articles at a third temperature for a third time period. The third temperature may be between the first and second temperatures while the third time period may be longer than the first time period but shorter than the second time period.

The first temperature may be in range of 85° C. to 100° C. with the first time period being in the range of 20 seconds to 90 seconds. More preferably the first temperature may be in range of 90° C. to 95° C. with the first time period being in the range of 30 seconds to 60 seconds. The second temperature may be in range of 55° C. to 75° C. with the second time period being in the range of 10 minutes to 25 minutes. More preferably the second temperature may be in range of 60° C. to 70° C. with the second time period being in the range of 15 minutes to 20 minutes. The third temperature may be in range of 80° C. to 95° C. with the third time period being in the range of 2 minutes to 10 minutes. More preferably the third temperature may be in range of 85° C. to 90° C. with the third time period being in the range of 3 minutes to 9 minutes.

The blanched potato articles may advantageously be cooled after the blanching step. Cooling may be effected by any appropriate means such as, for example, immersing the potato articles in cold water.

The method may advantageously include the step of partially drying said potato articles intermediate said blanching and coating steps. The partial drying may be effected by any appropriate means. Drying may be effected by the use of heated air. The air may be heated to a temperature of between 70° C. to 110° C.

The emulsion comprises a mixture of water, oil and starch. Other emulsion components may comprise any or all of the following: citric acid, colouring, sorbic acid, salt, egg, sugar, skimmed milk powder, stabiliser and emulsifier. Other food acids which may be included in the emulsion include acetic acid, lactic acid, malic acid, tartaric acid, hydrochloric acid, phosphoric acid and benzoic acid.

The emulsion may be heated prior to application to the potato articles. the emulsion may be applied by any appropriate means such as spraying. The articles may be agitated after being sprayed with the emulsion so as to ensure an even coating. In an alternative embodiment the potato articles may be dip coated with the emulsion. It will be appreciated that the emulsion is applied to, and remains on, the surface of the potato article. The emulsion does not penetrate the potato article.

The coated articles may be dried, as described above, by the use of heated air.

The step of introducing the coated potato articles into an elevated temperature environment may comprise placing the articles into an oven or like heating apparatus. The oven may be a fan-type oven which circulates heated air over the articles. The elevated temperature may be in the region of 100° C. to 170° C. More preferably the temperature may be in the region of 150° C. to 160° C. The time period during which the coated articles may be subjected to said elevated temperature may be in the range between 4 minutes to 40 minutes.

The drying steps of the invention may be quantified with reference to the moisture content of the potato articles. More particularly, the drying steps may be quantified with reference to a percentage increase in the dry matter (D.M.) content of the potato article.

Embodiments of the present invention will now be described by way of illustrative examples.

### EXAMPLE 1

Frying Chips 15 mm.

1. Pre-prepare mix for colouring batter:-

| | g. |
|---|---|
| Cumin | 100 |
| Paprika | 75 |
| Turmeric | 15 |

Mix is sufficient to prepare 700 kilos chips, so lower weight of the same proportions of ingredients may be prepared for experimental production. Colouring is not essential to the present invention, but may be desirable.

2. Prepare batter for dipping chips:-

| | g. |
|---|---|
| Water | 738 |
| Sunflower oil | 112 |
| Crisp Coat Starch | 122 |
| How 1 Stabilizer | 4 |
| Citric acid | 10 |
| Salt | 8 |
| Skimmed milk powder | 4 |
| Colour pre-mix | 2 |

How 1 stabilizer is available from G.C. Hahn & Co. of Lubeck, Germany. It includes Guargum (E412) and Xanthangum (E415). Crisp Coat Starch is supplied by National Starch & Chemical Co., Manchester, England.

3. Mix batter with high speed stirrer. If batter stands for more than one hour after mixing, re-stir. The batter is a relatively unstable emulsion.

4. Prepare chips. Use potatoes of high dry matter over 21%. Preferred varieties are Maris Piper, Russett Burbank, Agra, Asterix, Binge, Saturna. Peel, chip at 15 mm. cross section, remove slivers and nubbins.

5. Blanch 1 minute @ 95° C.

6. Blanch 15 minutes @ 70° C.

7. Blanch 8 minutes @ 90° C.

8. Dry to remove surface moisture from chips. Typically 5 minutes @ 100° C. Weight of 1 kilo raw chips after blanch & dry is typically 995 grams.

9. Stand chips to cool to 40° C. This typically takes a few minutes.

10. Dip in batter for 30 seconds and drain well. Weight of chips increases by about 6.5% to typically 1052 grams. As an alternative, for all examples, a desired weight of batter may be sprayed, and the product gently tumbled to give an even coating.

11. Dry such that chips have about 30.5% dry matter. In preliminary research, potatoes used had 22.5% dry matter. These were dried to remove 26%. The percentage reduction of potatoes of other dry matters may be calculated accordingly. In development, drying was done in air at 100° C. in domestic fan oven. The drying time in this method was approximately 40 minutes. Drying could be much quicker on specialised drying plant with higher air flow.

12. Par-cook chips for 10 minutes at 150° C. Weight will typically reduce to 682 grams.

13. Cool to 75° C., then fill into bags made for example from low permeability film, such as Pvdc coated polyester/polyethene. Bags are typically flushed with carbon dioxide, then sealed.

Chips contain about 0.73% calculated fat content.

The recommended fry before eating is 3 minutes @ 190° C.

### EXAMPLE 2

Frying Chips 8 mm.

1. Use colour pre-mix as for 15 mm chips.

2. Prepare batter for dipping chips:-

| | g. |
|---|---|
| Water | 771 |
| Sunflower oil | 100 |
| Crisp Coat Starch | 100 |
| How 1 Stabilizer | 4 |
| Citric acid | 6 |
| Lactic acid | 4 |
| Skimmed milk powder | 5 |
| Salt | 8 |
| Colour pre-mix | 2 |

3. Mix batter with high speed stirrer. If batter stands for more than one hour after mixing, re-stir. The batter is a relatively unstable emulsion.

4. Prepare chips. Use potatoes of high dry matter over 21%. Preferred varieties are Maris Piper, Russett Burbank, Agria, Asterix, Bintje, Saturna. Peel, chip at 8 mm. cross section, remove slivers and nubbins.

5. Blanch 1 minute @ 90° C.

6. Blanch 15 minutes @ 65° C.

7. Blanch 4 minutes @ 85° C.

8. Cool in cold running water.

9. Dry 5 minutes @ 100° C. Weight of 1000 g raw chips after blanch is about 1012 g.

10. Cool 2 minutes. Weight reduces to about 1008 g.

11. Dip in batter for 30 seconds. Drain well to remove excess batter. Weight after dip is about 1080 grams, an increase of 7.2%.

12. Dry such that chips have 30% dry matter. In preliminary research, potatoes with 22.5% dry matter were used, so weight is reduced by about 25%. Equivalent calculations should be made for potatoes of other dry matters. The weight reduction was achieved by drying in fan over for 20 minutes. Weight after dry about 750 grams.

13. Par-cook chips for 6 minutes at 150° C. Weight after cook is about 307 grams., 61.7% of raw weight

14. Cool to 75° C., then fill into bags made from e.g. low permeability film. Bags are typically flushed with carbon dioxide, then sealed.

The chips contain 1.0% fat.

The recommended final flying time is 2 minutes @ 180° C. The weight loss in fry is 35% and the fat uptake is 7% of weight of chips put in frier. The total fat content of fries on plate is 11.0%.

### EXAMPLE 3

Roast Potatoes

1. Use colour pre-mix as specified for 15 mm chips.

2. Make batter for dip (stir as necessary to maintain emulsion):-

| | g. |
|---|---|
| Water | 458.5 |
| Beaten egg | 255 |
| Sunflower oil | 136 |
| Crisp Coat Starch | 85 |
| How 1 Stabilizer | 3.5 |
| Colour pre-mix | 2.5 |
| Citric acid | 8.5 |
| Hydrochloric acid 32% | 10 |
| Salt | 10 |
| Sugar | 34 |

3. Peel potatoes and cut into pieces approximately rectangular with average weight of 50 g each.

4. Blanch 9 minutes @ 90° C. 1000 g. raw weigh about 1012 g after blanch.

5. Cool in cold running water and dry 5 minutes @ 120° C. Weight after dry about 995 g.

6. Dip for 30 seconds in batter and drain well. Weight after dip about 1041 grams. gain of 4.6%.

7. Dry to reduce weight by 25% at 120° C. In a domestic fan oven this takes 1 hour 30 minutes. Drying could be much quicker in commercial drier.

8. Cook 10 minutes in oven at 150° C. Weight after cook about 720 grams.

9. Cool to 75° C., then fill into bags as used for chips, flush with carbon dioxide, and seal.

10. To re-heat, spread on tray in oven and cook 15 minutes @ 200° C.

Fat content of roast potatoes 0.7%.

### EXAMPLE 4

Oven Chips 15 mm

1. Use colour pre-mix as specified for 15 mm Frying Chips.

2. Prepare batter for dipping chips:-

| | g. |
|---|---|
| Water | 640 |
| Sunflower oil | 202 |
| Crisp Coat Starch | 134 |
| How 1 Stabilizer | 2 |
| Skimmed milk powder | 5 |
| Colour pre-mix | 2 |
| Citric acid | 9 |
| Salt | 6 |

3. Mix batter with high speed stirrer. If batter stands for more than one hour after mixing, re-stir. The batter is an unstable emulsion.

4. Prepare chips. Use potatoes of high dry matter over 21%. Preferred varieties are Maris Piper, Russell Burbank, Agria, Asterix, Bintje, Saturna. Peel, chip at 15 mm. cross section, remove slivers and nubbins.

5. Blanch 12 minutes @ 90° C. Wash in running water to cool.

6. Dry for 5 minutes @ 100° C. to surface dry.

7. Dip in batter for 30 seconds and drain well. Weight increase in dipping 5.4%.

8. Dry to 100° C. to reduce weight by 25%. In domestic fan oven the drying time is 50 minutes. Drying is likely to be much quicker if commercial drier is used

9. Cook @ 160° C. for 10 minutes. Weight after cook is about 65% of raw weight.

10. Cool to 75° C., then fill into bags made from low permeability film, for example pvdc coated polyester/olyethylene. Bags are typically flushed with carbon dioxide, then sealed

11. A recommended cooking procedure is to spread chips thinly on pan and oven cook for 15 minutes @ 200° C.

Fat content of chips is 1.2%. After cooking in oven as above the fat content of chips on plate is 1.7%.

### EXAMPLE 5

Frying Chips and Oven Chips 15 mm

1. POTATOES
Variety: Maris Piper. Dry matter (DM): 24%. Reducing sugars very low. Heavy surface bruising removed in hand peeling.
   2. PREPARATION
Hand peeled. Chipped on hand operated chipper with 15 mm grid. Slivers and nubbins removed by hand.

3. BLANCHING AND DRYING

Any blanching technique is appropriate given that the objective of giving maximum flesh softening without surface breakdown or scuffing is achieved.

The blanch technique used was

1 minute @ 95° C.

20 minutes @ 65° C.

9 minutes @ 85° C.

Cool in running cold water

Dry surface of chip prior to coating, e.g. by putting in fan oven for 3 mins @ 100° C.

4. COATING MIX
The mix for one kilo of coating was:-

| | g. |
|---|---|
| Water | 532 |
| Sunflower oil | 246 |
| Starch | 91 |
| Citric acid | 16 |
| Colour pre-mix | 3.5 |
| Hamultop emulsifier | 9 |
| How 1 Stabilizer | 2 |
| Sorbic | 27.5 |
| Salt | 73 |

The colour pre-mix was made by mixing:—parts

| | parts |
|---|---|
| Cumin | 10 |
| Paprika | 7.5 |
| Turmeric | 1.5 |

All ingredients for the coating mix are put into a beaker and mixed with hand held high speed stirrer until stable emulsion is formed. The mix will remain sterile and keep for long periods if kept in air tight container and briefly re-stirred before use.

The starch used is Crisp Coat UC starch supplied by National Starch & Chemical Co., Manchester. The stabiliser and emulsifier are made by G.C. Hahn & Co., Lubeck, Germany. Hamultop is the trade name of an emulsifier made by G.C. Hahn Limited which includes concentrated whey powder.

The coating mix is intended to give extended shelf life to chips stored at ambient or chilled temperatures. If chips are to be stored and distributed frozen the Citric and sorbic acids may be omitted from the emulsion.

5. APPLICATION of EMULSION COATING

Emulsion is added to prepared chips at the rate of 5% of chip weight. In a continuous process this may be done by the combination of load cells and spraying. After spraying chips should be gently moved around to ensure an even coating of every chip. The dipping of chips in emulsion is not recommended for those to which acid is to be applied.

6. DRYING

After coating, chips are dried. Using the potatoes with 24% DM drying should continue till weight is reduced by 20% to give 30% DM. If potatoes of other DM's are used drying should be adjusted to give 30%.

7. HOT AIR TREATMENT

Immediately after drying when still warm chips are transferred to a domestic oven at 150° C. where they are held for 9 minutes. In a commercial situation a continuous oven may be appropriate, such as used for biscuit making. The temperature of about 150° is important. If temperature is significantly lower the light texture inside the chip is not achieved. If significantly higher the tips of the chips burn. Weight of chip is reduced by 29% of weight prior to dipping giving DM of 33.8% in finished chip.

8. PACKING

Chips are cooled after Hot Air treatment to about 60° C. and packed, for example with a CO₂ flush.

9. FAT CONTENT OF CHIPS
Calculated mathematically

| | % |
|---|---|
| Fat content of emulsion | 24.6 |
| Fat content of chips given 5% addition of above | 1.23 |
| Fat content of chips after losing 29% weight in heating | 1.73 |

10. FINAL PREPARATION BY CUSTOMER

Recommended methods are:
a) Fry chips. Three minutes in oil @ 180° C.
b) Oven chips. 10 minutes in oven @ 200° C.

### EXAMPLE 6

Frying Chips 8 mm

1. POTATOES

Same as used for Example 5.

2. PREPARATION

Same as for Example 5 but chipped to 8 mm.

3. BLANCHING AND DRYING

Prepared chips were blanched:—

30 seconds @ 90° C.

15 minutes @ 60° C.

3 minutes @ 85° C.

Chips were then dried for 3 minutes @ 100° C.

4. COATING MIX
The mix used to make one kilo was:-

| | g. |
|---|---|
| Water | 603 |
| Sunflower oil | 204 |
| Starch | 90 |
| Citric acid | 9 |
| Colour pre-mix | 2 |
| Hamultop emulsifier | 10 |
| Sorbic | 18 |
| How 1 Stabilizer | 4 |
| Salt | 60 |

The colour pre-mix is the same as for Example 5. Ingredients are mixed as described for Example 5 and sources are the same.

5. APPLICATION of EMULSION COATING

Emulsion is added to prepared chips at the rate of 8% of chip weight.

6. DRYING

Dry to reduce weight before coating by 23% by drying in air @ 100° C. Chip has DM of 37.5%.

7. HOT AIR TREATMENT

Hot air treatment of 5 minutes at 150° C. Weight loss from chip before drying 36% giving DM of 37.5%.

8. PACKING

As for Example 5.

9. FAT CONTENT OF CHIPS
Calculated mathematically

| | % |
|---|---|
| Fat content of emulsion | 20.4 |
| Fat content of chips given 8% addition | 1.63 |
| Fat content of chips after losing 36% weight | 2.55 |
| in heat process | |

10. FINAL PREPARATION

Recommended 2.5 minutes frying in oil @ 180° C.

### EXAMPLE 7

Roast Potatoes

1. POTATOES

Same as used for Examples 5 and 6. After peeling cut into pieces of approximately 40 mm cross section.

2. BLANCHING

Blanch 16 minutes @ about 85° C. The blanching technique is important. It should soften the flesh of the potato without gelatanizing starches, making them sticky.

Surface dry potato by putting in fan oven for 3 minutes @ 100° C.

4. COATING EMULSION
The mix used to make one kilo was:-

| | g. |
|---|---|
| Water | 240 |
| Sunflower oil | 250 |
| Beaten egg | 240 |
| Starch | 100 |
| Roast potato colour pre-mix | 4 |
| Citric acid | 40 |
| Salt | 80 |
| Hamultop emulsifier | 9.5 |
| How 1 Stabilizer | 0.5 |
| Sorbic acid | 36 |

Roast potato colour pre-mix contains:—

| | parts |
|---|---|
| Cumin | 4 |
| Paprika | 4 |
| Turmeric | 2 |

Emulsion is heated and maintained @ 40° C. and added to potato pieces at the rate of 2.5% of potato weight, and potatoes gently tumbled to ensure even coating over the whole surface.

4. DRYING

Dry to reduce weight of potato by about 25% giving 32% DM using potatoes with 24% DM. Using potatoes with other raw DM's calculate loss required to give 32% DM.

5. HOT AIR TREATMENT

Immediately after drying when still warm, transfer to fan oven at 150° C. where they are held for 20 minutes. Weight of potato is reduced by about 32.5% to 35.6%. DM

6. PACKING

As for Example 5.

7. FAT CONTENT OF CHIPS
Calculated mathematically

| | % |
|---|---|
| Fat content of emulsion;-;- | |
| Sunflower oil | 25.00 |
| Egg content 24% with fat @ 12.3 grams/100 | 3.00 |
| | 28.00 |
| Fat content with 2.5% emulsion | 0.70 |
| Fat content after drying 32.5% | 1.04 |

8. FINAL PREPARATION BY CUSTOMER

Recommended 10 minutes in oven @ 200° C. This is considerably shorter time than for existing products, and is believed to be due to the addition of egg to the emulsion causing browning and crisping when baked.

1. A method of preparing a potato based food product, the method comprising the steps of:
processing potatoes into potato articles having a desired size and shape;
blanching the potato articles;
coating the blanched potato articles with an emulsion, the emulsion containing starch;
at least partially drying the emulsion coated potato articles;
introducing the at least partially dried and coated potato articles into an elevated temperature environment for a predetermined period of time;
removing the potato articles from the environment and allowing the potato articles to cool; and
packing the potato articles.

2. The method of claim 1, wherein the step of processing the potatoes comprises washing and peeling the potatoes, followed by cutting the potatoes into the potato articles.

3. The method of claim 2, wherein the potatoes are cut into elongate sticks known as chips or fries.

4. The method of claim 3, wherein the elongate sticks have a cross-section of about 8 mm square.

5. The method of claim 3, wherein the elongate sticks have a cross-section of about 15 mm square.

6. The method of claim 1, wherein the blanching step comprises the utilisation of a succession of differing blanching temperatures for different time periods.

7. The method of claim 6 wherein the blanching step comprises blanching at a first temperature for a first time period followed by blanching at a second temperature for a second time period wherein the second temperature is less than the first temperature and the second time period is greater than the first time period.

8. The method of claim 7, wherein the blanching step further comprises a third blanching procedure following the second blanching procedure, the third blanching procedure including blanching the potato articles at a third temperature for a third time period.

9. The method of claim 8, wherein the third temperature is between the first and second temperatures and the third time period is longer than the first time period and shorter than the second time period.

10. The method of claim 7, wherein the first temperature is in a range of 85° C. to 100° C.

11. The method of claim 10, wherein the first temperature is in a range of 90° C. to 95° C.

12. The method of claim 7, wherein the second temperature is in a range of 55° C. to 75° C.

13. The method of claim 12, wherein the second temperature is in a range of 60° C. to 70° C.

14. The method of claim 9, wherein the third temperature is in a range of 80° C. to 90° C.

15. The method of claim 14, wherein the third temperature is in a range of 85° C. to 90° C.

16. The method of claim 2, wherein the desired shape is a rounded shape.

17. The method of claim 3, wherein the blanching step comprises blanching at a substantially uniform temperature for a predetermined time.

18. The method of claim 17, wherein the blanching temperature is in a range of 80° C. to 95° C.

19. The method of claim 18, wherein the blanching temperature is in a range of 85° C. to 90° C.

20. The method of claim 1, wherein the blanched potato articles are cooled after the blanching step.

21. The method of claim 20 wherein cooling is effected by immersing the potato articles in cold water.

22. (cancelled)

23. The method of claim 36, wherein the partial drying is effected by utilising heated air.

24. The method of claim 23, wherein the air is heated to a temperature of between 90° C. and 110° C.

25. The method of claim 1, wherein the emulsion comprises a mixture of water, oil and starch.

26. The method of claim 25, wherein the emulsion includes at least one ingredient selected from the group consisting of citric acid, colouring, sorbic acid, salt, egg, sugar, skimmed milk powder, stabiliser, emulsifier and hydrochloric acid.

27. The method of claim 1, wherein the emulsion is heated prior to the coating step.

28. The method of claim 1, wherein the coating step includes spraying the emulsion on the potato articles.

29. The method of claim 28, further comprising agitating the potato articles after spraying the potato articles with the emulsion.

30. The method of claims 1, wherein the coating step includes dip coating the potato articles with the emulsion.

31. The method of claim 1, wherein the step of introducing the coated potato articles into the elevated temperature environment comprises placing the potato articles into a heated apparatus.

32. The method of claim 31, wherein the heated apparatus is a fan-type oven which circulates heated air over the potato articles.

33. The method of claim 1, wherein the elevated temperature environment has a temperature in a range of 100° C. to 170° C.

34. The method of claim 33, wherein the temperature is in a range of 150° C. to 160° C.

35. The method of claim 1, wherein the predetermined period of time is in a range between 4 minutes and 40 minutes.

36. A method of preparing a potato based food product, the method comprising the steps of:
processing potatoes into potato articles having a desired size and shape;
blanching the potato articles;
partially drying the blanched potato articles;
coating the partially dried and blanched potato articles with an emulsion, the emulsion containing starch;
introducing the at least partially dried and coated potato articles into an elevated temperature environment for a predetermined period of time;
removing the potato articles from the environment and allowing the potato articles to cool; and
packing the potato articles.

37. The method of claim 10, wherein the first time period is in a range of 20 seconds to 90 seconds.

38. The method of claim 11, wherein the first time period is in a range of 30 seconds to 60 seconds.

39. The method of claim 12, wherein the second time period is in a range of 10 minutes to 25 minutes.

40. The method of claim 13, wherein the second time period is in a range of 15 minutes to 20 minutes.

41. The method of claim 14, wherein the third time period is in a range of 2 minutes to 10 minutes.

42. The method of claim 15, wherein the third time period is in a range of 3 minutes to 9 minutes.

43. The method of claim 18, wherein the predetermined time is in a range of 5 minutes td 20 minutes.

44. The method of claim 19, wherein the predetermined time is in a range of 9 minutes to 16 minutes.
